(19) United States
(12) Patent Application Publication
(10) Pub. No.: US 2013/0171290 A1
(43) Pub. Date: Jul. 4, 2013

(54) Mold-Tool System having Actuator Assembly Including Piston Assembly and Flexible Diaphragm Assembly

(71) Applicants: Thomas Anthony St. Gelais, Colchester, VT (US); Paul Blais, South Burlington, VT (US)

(72) Inventors: Thomas Anthony St. Gelais, Colchester, VT (US); Paul Blais, South Burlington, VT (US)

(73) Assignee: HUSKY INJECTION MOLDING SYSTEMS LTD., Bolton, ON (CA)

(21) Appl. No.: 13/821,011

(22) PCT Filed: Aug. 12, 2011
(86) PCT No.: PCT/US11/47503

§ 371 Date: Mar. 6, 2013

Related U.S. Application Data
(60) Provisional application No. 61/382,040, filed on Sep. 13, 2010.

(51) Int. Cl. B29C 45/18

(52) U.S. Cl. CPC B29C 45/18
USPC 425/542

(57) ABSTRACT

A mold-tool system (100), comprising: a stationary plate (102); and an actuator assembly (104) being supported by the stationary plate (102), the actuator assembly (104) having: a piston assembly (106) being movable in the stationary plate (102); and a flexible diaphragm assembly (108) being connected with the piston assembly (106) and with the stationary plate (102).

### TECHNICAL FIELD

An aspect generally relates to (but is not limited to): (i) a mold-tool system having an actuator assembly including a piston assembly, and a flexible diaphragm assembly, and/or a molding system having the mold-tool system.

### BACKGROUND

The first man-made plastic was invented in Britain in 1851 by Alexander PARKES. He publicly demonstrated it at the 1862 International Exhibition in London, calling the material Parkesine. Derived from cellulose, Parkesine could be heated, molded, and retain its shape when cooled. It was, however, expensive to produce, prone to cracking, and highly flammable. In 1868, American inventor John Wesley HYATT developed a plastic material he named Celluloid, improving on PARKES' concept so that it could be processed into finished form. HYATT patented the first injection molding machine in 1872. It worked like a large hypodermic needle, using a plunger to inject plastic through a heated cylinder into a mold. The industry expanded rapidly in the 1940s because World War II created a huge demand for inexpensive, mass-produced products. In 1946, American inventor James Watson HENDRY built the first screw injection machine. This machine also allowed material to be mixed before injection, so that colored or recycled plastic could be added to virgin material and mixed thoroughly before being injected. In the 1970s, HENDRY went on to develop the first gas-assisted injection molding process. Injection molding machines consist of a material hopper, an injection ram or screw-type plunger, and a heating unit. They are also known as presses, they hold the molds in which the components are shaped. Presses are rated by tonnage, which expresses the amount of clamping force that the machine can exert. This force keeps the mold closed during the injection process. Tonnage can vary from less than five tons to 6000 tons, with the higher figures used in comparatively few manufacturing operations. The amount of total clamp force is determined by the projected area of the part being molded. This projected area is multiplied by a clamp force of from two to eight tons for each square inch of the projected areas. As a rule of thumb, four or five tons per square inch can be used for most products. If the plastic material is very stiff, more injection pressure may be needed to fill the mold, thus more clamp tonnage to hold the mold closed. The required force can also be determined by the material used and the size of the part, larger parts require higher clamping force. With Injection Molding, granular plastic is fed by gravity from a hopper into a heated barrel. As the granules are slowly moved forward by a screw-type plunger, the plastic is forced into a heated chamber, where it is melted. As the plunger advances, the melted plastic is forced through a nozzle that rests against the mold, allowing it to enter the mold cavity through a gate and runner system. The mold remains cold so the plastic solidifies almost as soon as the mold is filled. Mold assembly or die are terms used to describe the tooling used to produce plastic parts in molding. The mold assembly is used in mass production where thousands of parts are produced. Molds are typically constructed from hardened steel, etc. Hot-runner systems are used in molding systems, along with mold assemblies, for the manufacture of plastic articles. Usually, hot-runners systems and mold assemblies are treated as tools that may be sold and supplied separately from molding systems.

United States Patent Application Number 2006/0222730 discloses an injection molding machine that includes a nozzle member and a diaphragm member fixedly coupled within first mold section. The diaphragm member is generally an inverted T-shaped member threadedly engaged within nozzle member.

### SUMMARY

The inventors have researched a problem associated with known molding systems that inadvertently manufacture bad-quality molded articles or parts. After much study, the inventors believe they have arrived at an understanding of the problem and its solution, which are stated below, and the inventors believe this understanding is not known to the public. Known systems create friction between a piston seal and an air cylinder. The increased friction reduces efficiency of a pneumatic actuator. Air pressure that could be used to apply force to the valve stem is used to overcome friction. Since there are manufacturing tolerances between installations, friction is not the same in all cylinders. Friction variability creates non-synchronous valve stem actuation. The double-delta creates 60% of the non-synchronous valve stem actuation. Piston seal to a cylinder interface wears over time. The wear results in two issues: (i) air leakage and (ii) scoring of the cylinder resulting in permanent damage. The high pre-load on the double delta results in permanent deformation of the cylinder and requires replacement. Known installations require special tools due to high installation forces.

According to one aspect, there is provided a mold-tool system (100), comprising: a stationary plate (102); and an actuator assembly (104) being supported by the stationary plate (102), the actuator assembly (104) having: a piston assembly (106) being movable in the stationary plate (102); and a flexible diaphragm assembly (108) being connected with the piston assembly (106) and with the stationary plate (102).

According to another aspect, there is provided a molding system (300) having the mold-tool system (100).

Use of a diaphragm assembly (108) may have the following advantages: (i) lower friction, (ii) reduced wear, (iii) reduced air leakage, (iv) easier installation, (v) enable higher stem force for same diameter and air pressure, and/or (vi) more compliant than the known piston/cylinder assembly.

Other aspects and features of the non-limiting embodiments will now become apparent to those skilled in the art upon review of the following detailed description of the non-limiting embodiments with the accompanying drawings.

### DETAILED DESCRIPTION OF THE DRAWINGS

The non-limiting embodiments will be more fully appreciated by reference to the following detailed description of the non-limiting embodiments when taken in conjunction with the accompanying drawings, in which:

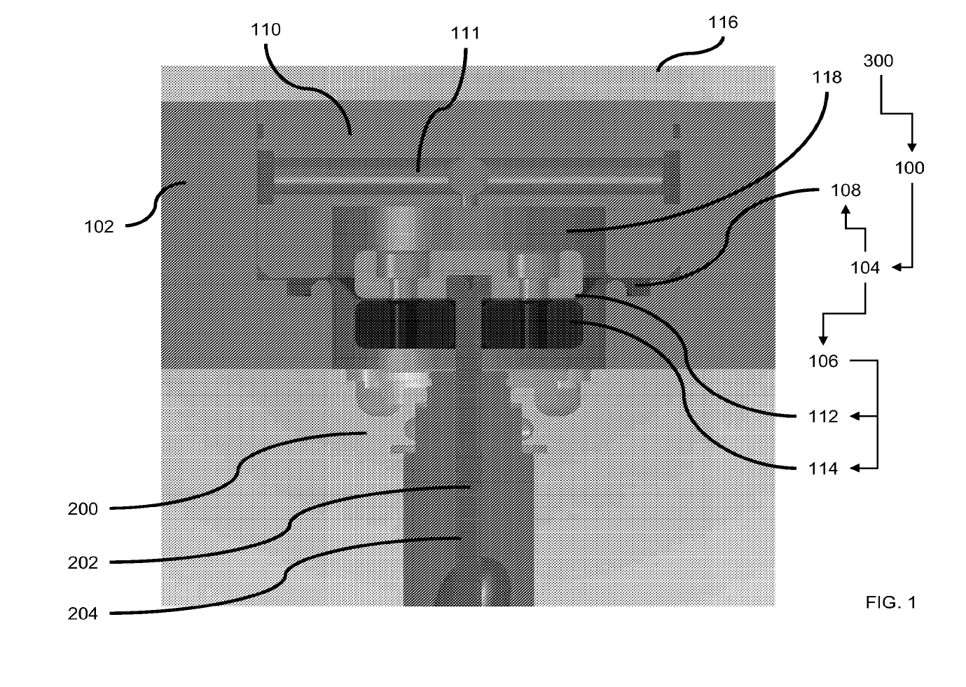

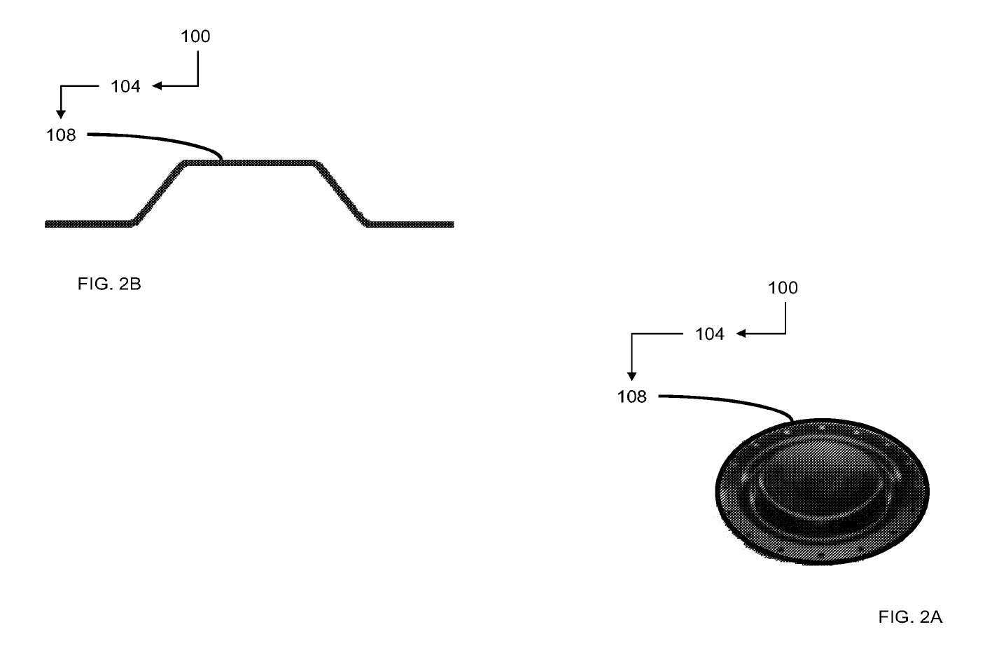

FIGS. 1, 2A, 2B depict schematic representations of a mold-tool system (100).

The drawings are not necessarily to scale and may be illustrated by phantom lines, diagrammatic representations and fragmentary views. In certain instances, details not necessary for an understanding of the embodiments (and/or details that render other details difficult to perceive) may have been omitted.

### DETAILED DESCRIPTION OF THE NON-LIMITING EMBODIMENT(S)

FIGS. 1, 2A, 2B depict the schematic representations of the mold-tool system (100) of a molding system (300). FIGS. 1 and 2B depict cross-sectional views and FIG. 2A depicts a perspective view of the mold-tool system (100). The mold-tool system (100) and the molding system (300) may be provided together or may be sold separately; that is, the molding system (300) may have the mold-tool system (100). These systems may include components that are known to persons skilled in the art, and these known components will not be described here. Examples of the known components are: back-up pad (200), a stem (202), a nozzle housing (204), etc. These known components are described, at least in part, in the following reference books (for example): (i) “Injection Molding Handbook” authored by OSSWALD/TURNG/GRAMANN (ISBN: 3-446-21669-2), (ii) “Injection Molding Handbook” authored by ROSATO AND ROSATO (ISBN: 0-412-99381-3), (iii) “Injection Molding Systems” 3^{rd} Edition authored by JOHANNABER (ISBN 3-446-17733-7) and/or (iv) “Runner and Gating Design Handbook” authored by BEAUMONT (ISBN 1-446-22672-9). It will be appreciated that for the purposes of this document, the phrase “includes (but is not limited to)” is equivalent to the word “comprising”. The word “comprising” is a transitional phrase or word that links the preamble of a patent claim to the specific elements set forth in the claim which define what the invention itself actually is. The transitional phrase acts as a limitation on the claim, indicating whether a similar device, method, or composition infringes the patent if the accused device (etc) contains more or fewer elements than the claim in the patent. The word “comprising” is to be treated as an open transition, which is the broadest form of transition, as it does not limit the preamble to whatever elements are identified in the claim.

The mold-tool system (100) includes (but is not limited to): (i) a stationary plate (102), and (ii) an actuator assembly (104). The actuator assembly (104) is supported by the stationary plate (102). The actuator assembly (104) has (and is not limited to): (i) a piston assembly (106), and (ii) a flexible diaphragm assembly (108). The piston assembly (106) is movable in the stationary plate (102). The flexible diaphragm assembly (108) is connected with the piston assembly (106) and with the stationary plate (102).

The mold-tool system (100) may further include (and is not limited to): a fluid-delivery assembly (110) that is configured to deliver a fluid, under pressure, to the actuator assembly (104). The stationary plate (102) receives, at least in part, the fluid-delivery assembly (110). The fluid-delivery assembly (110) may be positioned adjacent the actuator assembly (104). The piston assembly (106) may optionally include (by way of example): (i) a first portion (112), and (ii) a second portion (114), and the flexible diaphragm assembly (108) is positioned between the first portion (112) and the second portion (114).

The stationary plate (102) may define a recess that is configured to receive, at least in part, the fluid-delivery assembly (110). The fluid-delivery assembly (110) may define a fluid-delivery channel (111) that is configured to deliver a fluid, under pressure, to the actuator assembly (104). The combination of the fluid-delivery assembly (110) and the stationary plate (102) may define a fluid chamber (118). The fluid-delivery channel (111) is in communication with the fluid chamber (118). The piston assembly (106) may be received in the fluid chamber (118). The stationary plate (102) may define a groove (within the fluid chamber (118)) that fixedly receives, at least in part, an outer periphery of the flexible diaphragm assembly (108). The inner region of the flexible diaphragm assembly (108) may be fixedly held in place (that is, sandwiched) between the first portion (112) and the second portion (114) of the piston assembly (106). The stem (202) may be attached to the piston assembly (106).

For an actuation operation, the fluid (such as air, etc) is received, under pressure, in the fluid-delivery channel (111) and pushed into the fluid chamber (118) and the fluid then pushes the piston assembly (106) forward and the flexible diaphragm assembly (108) stretches so as to permit limited forward movement of the piston assembly (106) so that the stem (202) may be moved forward enough so that a molding material may be permitted to leave the nozzle housing (204) and enter a mold assembly (not depicted but known).

For a de-actuation operation, the fluid removed from the fluid-delivery channel (111) and from the fluid chamber (118), and the fluid then pulls the piston assembly (106) backward and the flexible diaphragm assembly (108) stretches in the opposite direction to that of the actuation operation so as to permit limited backward movement of the piston assembly (106) so that the stem (202) may be moved backward enough so that a molding material may be not be permitted to leave the nozzle housing (204) and enter the mold assembly.

It will be appreciated that the concept described above may be used for individual stem actuation, clustered stem actuation (such as four stems on one piston), and/or plate actuation.

It is understood that the scope of the present invention is limited to the scope provided by the independent claim(s), and it is also understood that the scope of the present invention is not limited to: (i) the dependent claims, (ii) the detailed description of the non-limiting embodiments, (iii) the summary, (iv) the abstract, and/or (v) description provided outside of this document (that is, outside of the instant application as filed, as prosecuted, and/or as granted). It is understood, for the purposes of this document, the phrase “includes (and is not limited to)” is equivalent to the word “comprising”. It is noted that the foregoing has outlined the non-limiting embodiments (examples). The description is made for particular non-limiting embodiments (examples). It is understood that the non-limiting embodiments are merely illustrative as examples.

What is claimed is:

1. A mold-tool system (100), comprising:
a stationary plate (102); and
an actuator assembly (104) being supported by the stationary plate (102), the actuator assembly (104) having:
a piston assembly (106) being movable in the stationary plate (102); and
a flexible diaphragm assembly (108) being connected with the piston assembly (106) and with the stationary plate (102).

2. The mold-tool system (100) of claim 1, further comprising:
a fluid-delivery assembly (110) being configured to deliver a fluid, under pressure, to the actuator assembly (104), the stationary plate (102) receiving, at least in part, the fluid-delivery assembly (110), and the fluid-delivery assembly (110) being positioned adjacent the actuator assembly (104).

3. The mold-tool system (100) of claim 1, wherein:
the piston assembly (106) includes:
a first portion (112); and
a second portion (114), and the flexible diaphragm assembly (108) being positioned between the first portion (112) and the second portion (114).

4. A molding system (300) having the mold-tool system (100) of claim 1.
